(19) United States
(12) Patent Application Publication
(10) Pub. No.: US 2004/0148489 A1
(43) Pub. Date: Jul. 29, 2004

(54) Sideband VLIW processor

(75) Inventor: Peter C. Damron, Fremont, CA (US)

Correspondence Address: ZAGORIN O'BRIEN & GRAHAM, L.L.P., 7600B N. CAPITAL OF TEXAS HWY., SUITE 350, AUSTIN, TX, 78731, US

(73) Assignee: Sun Microsystems, Inc.

(21) Appl. No.: 10/352,588

(22) Filed: Jan. 28, 2003

(51) Int. Cl. G06F 15/00

(52) U.S. Cl. 712/24; 712/215

(57) ABSTRACT

A sideband VLIW processing technique is provided. The sideband VLIW processing technique utilizes processor executable code and sideband information that identifies grouping and scheduling of the processor instructions to be executed by a sideband VLIW processor. The sideband information is ignored by processors without sideband VLIW processing capability, thus providing backward compatibility for the processor executable code. The sideband VLIW processor does not have the run-time scheduling circuitry of superscalar processors and instead has circuitry to read and interpret sideband information. Multiple sets of sideband information can be provided for a single corresponding executable program, one set for each different sideband VLIW processor implementation.

### BACKGROUND

1. Field of the Invention

The present invention relates to the field of processors and more particularly to the parallel execution of multiple superscalar instructions.

2. Description of the Related Art

A computer system typically has one or more processors. A processor executes a stream of instructions, performs calculations, reads and writes to memory, and the like. There are many types and families of processors, each with its own architecture and instruction set. Typically, a processor cannot execute a stream of instructions produced for another processor of a different processor architecture. For example, superscalar processors and Very Large Instruction Word (VLIW) processors have two different processor architectures and cannot execute the same instruction stream.

Superscalar processors have multiple pipelines and thus can execute more than one instruction at a time. Superscalar processors include dedicated circuitry to read an instruction stream, determine instruction dependencies, and dispatch instructions to the multiple pipelines. Many Complex Instruction Set Computing (CISC) and Reduced Instruction Set Computing (RISC) processors are superscalar.

CISC processors were introduced at a time when memory was very expensive. A CISC instruction set has hundreds of program instructions of varying length. Simple instructions only take a few bits, conserving memory. Variable-length instructions are more difficult to process. However, backward compatibility drives the continued use of CISC processor architectures, even though computer system designers are no longer concerned with memory conservation.

RISC processors use a small number of relatively simple, fixed-length instructions, typically the same number of bits long. Although this wastes some memory by making programs bigger, the instructions are easier and faster to execute. Because they have to deal with fewer types of instructions, RISC processors require fewer transistors than comparable CISC chips and generally deliver higher performance at similar clock speeds, even though they may have to execute more of their shorter instructions to accomplish a given function.

Superscalar processors have multiple pipelines or functional units. Superscalar processors are presented with a serial instruction stream and use complex circuitry to coordinate parallel execution of multiple instructions at run time attempting to keep as many functional units busy at a given time as possible.

VLIW processors also have multiple pipelines and can execute multiple instructions in parallel. However, VLIW processors don't have the complex control circuitry that supersealar chips use to coordinate parallel execution. Instead, VLIW processors rely on compilers to pack and schedule the instructions in the most efficient manner. A VLIW compiler, also referred to as a trace scheduling compiler, performs instruction-scheduling and uses various techniques to assess very large sequences of operations, through many branches, and schedule the executable program combining two or more instructions into a single bundle or packet. The compiler prearranges the bundles so the VLIW processor can quickly execute the instructions in parallel, freeing the processor from having to perform the complex and continual runtime analysis that superscalar RISC and CISC chips must do. VLIW architecture has low level parallelism in the code (also called ILP, instruction level parallelism) which is explicitly provided in the instruction stream of the executable program.

VLIW architectures do not have object-code compatibility within a given family of chips. For example, a VLIW processor with six pipelines cannot execute the same code as one with four pipelines. Because superscalar processors determine the parallelism at run time, different superscalar processors can execute the same executable program. However, a superscalar processor has some run-time overhead, usually several pipeline stages to do the grouping and scheduling for determining instruction level parallelism (ILP). The run-time overhead of superscalar processors increases for higher degrees of desired instruction level parallelism.

It is desirable to combine the object code compatibility of superscalar processors with the lower run-time overhead of VLIW processors in a next generation processor.

### SUMMARY

A sideband VLIW processing technique is provided. The sideband VLIW processing technique utilizes processor executable code and sideband information that identifies grouping and scheduling of the processor instructions to be executed by a sideband VLIW processor. The sideband information is ignored by processors without sideband VLIW processing capability, thus providing backward compatibility for the processor executable code. The sideband VLIW processor does not have the run-time scheduling circuitry of superscalar processors and instead has circuitry to read and interpret sideband information. The sideband VLIW processor does not require a new instruction set to make instruction level parallelism explicit. Like superscalar processors, the sideband VLIW processor can use an existing instruction set, but it can also exploit instruction level parallelism by using sideband information, and thus it can decrease or eliminate the run-time overhead for discovering the instruction level parallelism. Multiple sets of sideband information can be provided for a single corresponding executable program, one set for each different sideband VLIW processor implementation.

Accordingly, in some embodiments, a processor includes a functional unit for executing a sequence of processor instructions, and a sideband interpreter configured to process sideband information corresponding to the sequence of processor instructions.

In some embodiments, the sideband interpreter is further configured to order, group, and dispatch the sequence of instructions to the functional unit according to the sideband information.

In some embodiments, the processor further includes a sideband program counter, and a sideband translation look-aside buffer. The sideband program counter and the sideband translation look-aside buffer work in conjunction to track and translate an instruction address to the corresponding sideband information address.

In some embodiments, the sideband interpreter is further configured to coordinate bypassing between the functional unit and another functional unit.

In some embodiments, the sideband interpreter is further configured to identify which communication paths between the functional unit and a register are to be used to send a variable between the register and the functional unit.

In some embodiments, the sideband information is a sequence of instructions stored on computer readable media with the sequence of processor instructions.

In some embodiments, a different set of sideband information is used for a different processor implementation.

The foregoing summary contains, by necessity, simplifications, generalizations and omissions of detail; consequently, those skilled in the art will appreciate that the summary is illustrative only and is not intended to be in any way limiting. As will also be apparent to one of skill in the art, the operations disclosed herein may be implemented in a number of ways, and such changes and modifications may be made without departing from this invention and its broader aspects. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings.

FIG. 1, labeled prior art, is a block diagram depicting an illustrative superscalar processor architecture.

FIG. 2 illustrates a sideband VLIW processor architecture according to an embodiment of the present invention.

FIGS. 3A-3B illustrate exemplary encoding formats for sideband information according to embodiments of the present invention.

FIGS. 4A-4B illustrates an exemplary compilation process according to an embodiment of the present invention.

The use of the same reference symbols in different drawings indicates similar or identical items.

### DESCRIPTION OF THE PREFERRED EMBODIMENT(S)

A sideband VLIW processing technique is provided. The sideband VLIW processing technique utilizes superscalar executable code and sideband information that identifies grouping and scheduling of the superscalar instructions to be executed by a sideband VLIW processor. A smart compiler or other software tool produces sideband information corresponding to a superscalar executable program (also referred to as binary or object code). Alternatively, a programmer produces sideband information at the assembly level while programming the source code. Sideband information can be stored in the same file as the executable program or can be one or more separate files. The sideband information is ignored by processors without sideband VLIW processing capability, thus providing backward compatibility for the superscalar executable program. The sideband VLIW processor does not have the run-time scheduling circuitry of superscalar processors and instead has circuitry to read and interpret sideband information. The sideband VLIW processor does not require a new instruction set to make instruction level parallelism explicit. Like superscalar processors, the sideband VLIW processor can use an existing instruction set, but it can also exploit instruction level parallelism by using sideband information, and thus it can decrease or eliminate the run-time overhead for discovering the instruction level parallelism. Multiple sets of sideband information can be provided for a single corresponding executable program, one set for each different sideband VLIW processor architecture.

The description that follows presents a series of systems, apparatus, methods and techniques that facilitate the sideband VLIW processing technique. While much of the description herein assumes a single processor, process or thread context, some realizations in accordance with the present invention provide sideband VLIW processing customizable for each processor of a multiprocessor, each process and/or each thread of execution. Accordingly, in view of the above, and without limitation, certain exemplary exploitations are now described.

Superscalar Processor Architecture

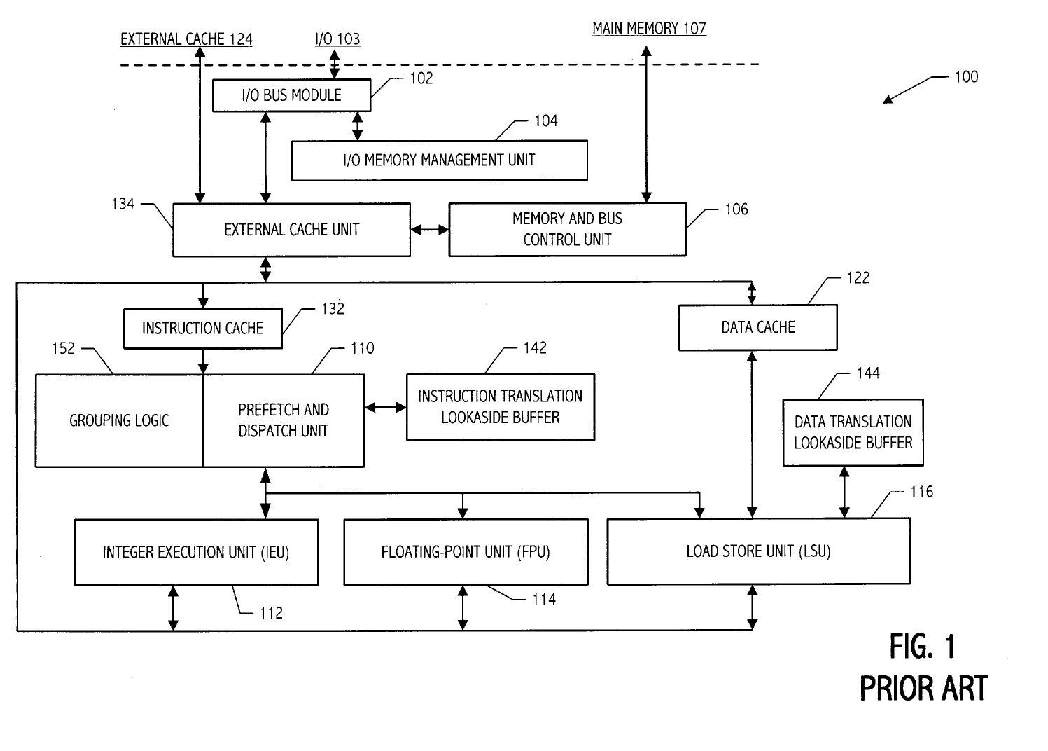

FIG. 1, labeled prior art, is a block diagram depicting an illustrative superscalar processor architecture. Processor 100 integrates an I/O bus module 102 to interface directly with an I/O bus 103, an I/O memory management unit 104, and a memory and bus control unit 106 to manage all transactions to main memory 107. A Prefetch and Dispatch Unit (PDU) 110 ensures that all execution units, including an Integer Execution Unit (IEU) 112, a Floating Point Unit (FPU) 114, and a Load-Store Unit (LSU) 116, remain busy by fetching instructions before the instructions are needed in the pipeline. A memory hierarchy of processor 100 includes a data cache 122 associated with LSU 116 as well as an external cache 124, main memory 107 and any levels (not specifically shown) of additional cache or buffering. Instructions can be prefetched from all levels of the memory hierarchy, including instruction cache 132, external cache 124, and main memory 107. External cache unit 134 manages all transactions to external cache 124.

A multiple entry, for example, 64-entry, instruction translation look-aside buffer (iTLB) 142 and a multiple entry data TLB (dTLB) 144 provide memory management for instructions and data, respectively. ITLB 142 and dTLB 144 provide mapping between, for example, a 44-bit virtual address and a 41-bit physical address.

Issued instructions are collected, reordered, and then dispatched to IEU 112, FPU 114 and LSU 116 by grouping logic 152 and a prefetch and dispatch unit (PDU) 110. The complex circuitry in grouping logic 152 coordinates parallel execution of multiple instructions at run time. Instruction reordering allows an implementation to perform some operations in parallel and to better allocate resources. The reordering of instructions is constrained to ensure that the results of program execution are the same as they would be if the instructions were performed in program order (referred to as processor self-consistency). Grouping logic 152 of PDU 110 re-discovers parallelism, spends several cycles analyzing instructions, determining which registers the instructions use, determining instruction dependencies and whether instructions have completed.

IEU 112 can include multiple arithmetic logic units for arithmetic, logical and shift operations, and one or more integer multipliers and dividers. IEU 112 is also integrated with a multi-window internal register file (not shown) utilized for local storage of operands. IEU 112 also controls the overall operation of the processor. IEU 112 executes the integer arithmetic instructions and computes memory addresses for loads and stores. IEU 112 also maintains the program counters and can control instruction execution for FPU 114 and LSU 116. This control logic can also be located in PDU 110.

FPU 114 can include multiple separate functional units to support floating-point and multimedia operations. These functional units include, for example, multiple multiply, add, divide and graphics units. The separation of execution units enables processor 100 to issue and execute multiple floating-point instructions per cycle. Source and data results are stored in a multi-entry FPU internal register file (not shown).

LSU 116 is responsible for generating the virtual address of all loads and stores, for accessing the data cache, for decoupling load misses from the pipeline through a load queue, and for decoupling the stores through a store queue. One load or one or more stores can be issued per cycle. During context switches LOAD and STORE instructions save off internal registers to memory.

The design of processor 100 is reminiscent of that of certain SPARC architecture based processors. Note that descriptions and/or terminology consistent with the SPARC architecture are used herein purely for illustrative purposes and, based on the description herein, persons of ordinary skill in the art will appreciate exploitations of the present invention suitable for a wide variety of processor implementations and architectures. SPARC architecture based processors are available from Sun Microsystems, Inc., Santa Clara, Calif. SPARC trademarks are used under license and are trademarks or registered trademarks of SPARC International, Inc. in the United States and other countries. Products bearing SPARC trademarks are based upon an architecture developed by Sun Microsystems, Inc.

Sideband VLIW Processor Architecture

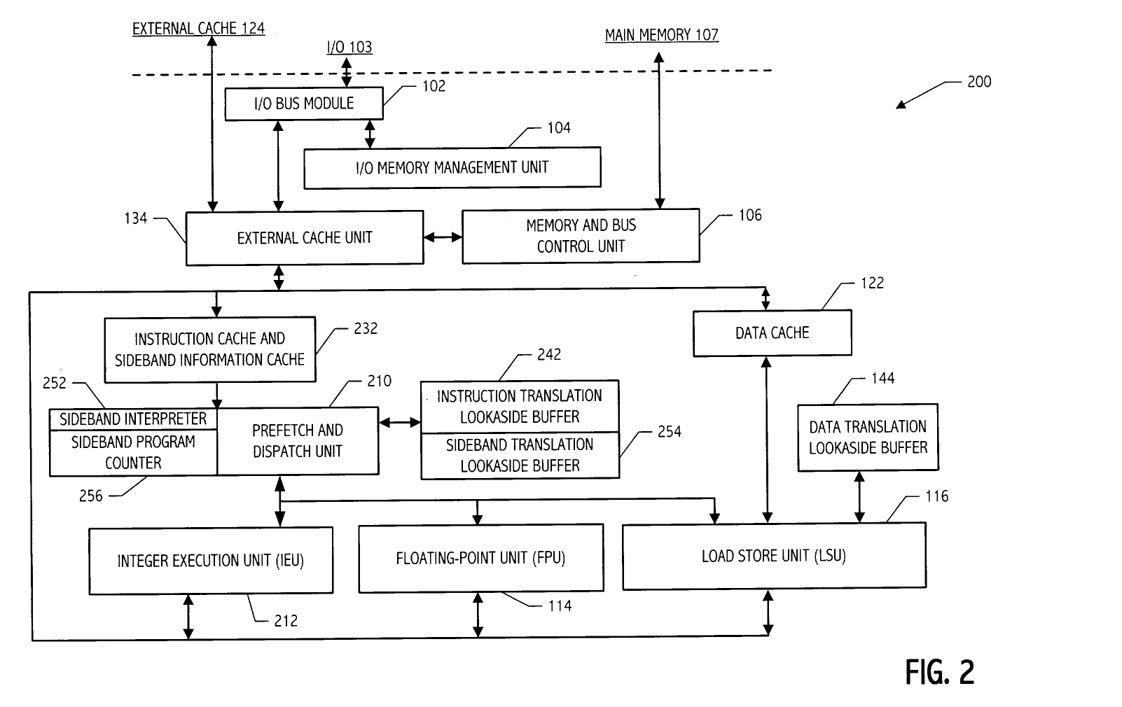

FIG. 2 illustrates a sideband VLIW processor architecture according to an embodiment of the present invention. A sideband VLIW processor 200 is based roughly on superscalar processor 100 with certain functionality differences. In particular, the functionality of PDU 210, IEU 212, instruction cache 232 and iTLB 242 includes sideband information specific circuitry.

Sideband information can be stored in a sideband portion of instruction cache 232. Thus, sideband information can be easily related to individual instructions, and can be accessed quickly by the processor pipeline. Part of filling a line in instruction cache 232 can include finding, decoding, and installing the sideband information for that cache line. Lines from a sideband information file and a corresponding executable file are loaded into instruction cache 232 from, for example, main memory or a disk drive. Alternatively, sideband VLIW processor 200 can have a separate sideband information cache (not shown) rather than combining sideband information with instructions in instruction cache 232.

A sideband interpreter 252 in PDU 210 parses instructions and sideband information and distributes the instructions to the various execution units according to sideband information. Thus, several stages of the processor pipeline normally dedicated to collecting and reordering instructions in a superscalar processor can be removed in sideband VLIW processor 200. Thus, sideband VLIW processor 200 executes a superscalar instruction set faster.

Sideband interpreter 252 can be configured to arrange for delay between the execution of successive instructions. Alternatively or additionally, sideband interpreter 252 can be configured to allow for reordering the execution of successive instructions. Alternatively or additionally, sideband interpreter 252 can be configured to arrange for groupings for execution of successive instructions. Alternatively or additionally, sideband interpreter 252 can be configured to coordinate the execution of multiple instructions in the same clock cycle.

A sideband TLB 254 in iTLB 242 provides memory management for sideband information. Sideband TLB 254 tracks instruction to sideband information locations. For example, when an instruction takes a branch, the program execution is sent to a different set of instructions. Thus, a similar location must be found in the corresponding sideband information. VLIW processor 200 can alternatively have a separate sideband information TLB (not shown) rather than combining sideband TLB 254 with iTLB 242.

If the sideband information per instruction is the same size as an instruction, then the sideband information address can be computed as follows: the instruction counter address can be broken into a page number plus a page offset, and the instruction page number mapped to a sideband information page number, and the sideband information address computed as the sideband information page number plus the page offset from the instruction counter address.

If the sideband information per instruction differs by a constant scale factor from the instruction size, then the sideband information address can be computed as follows: the instruction addresses can be partitioned into base and size contiguous segments, and the program counter address can be used to search the set of base and size pairs to find the instruction segment base and size. This instruction segment can be mapped to an associated sideband information segment with a base and size, and the sideband information address can be computed as: (instruction address−instruction segment base)*scale factor+sideband information base.

Sideband TLB 254 can contain a searchable set of entries. For example, a search for a particular entry can be based on instruction page address and sideband information page address. Alternatively, a search for a particular entry can be based on instruction segment base address, instruction segment size, sideband information segment base address, and a scaling factor.

IEU 212 can include multiple arithmetic logic units for arithmetic, logical and shift operations, and one or more integer multipliers and dividers. IEU 212 is also integrated with a multi-window internal register file (not shown) utilized for local storage of operands. IEU 212 also controls the overall operation of the processor. IEU 212 executes the integer arithmetic instructions and computes memory addresses for loads and stores.

In addition, IEU 212 also maintains the program counters and can control instruction execution for FPU 114 and LSU 116. This control logic can also be in PDU 210. IEU 212 also maintains a sideband program counter 256 to track similar locations in the sideband information. Sideband program counter 256 works with sideband TLB 254 to track and translate a normal instruction address to the corresponding sideband information address. If the sideband information is stored in the instruction cache, then the sideband program counter may not be necessary.

Sideband VLIW processor 200 can execute superscalar instruction sets providing object code compatibility between different processor architectures. In addition, single threaded code executes efficiently on a sideband VLIW processor with multiple functional units.

In one embodiment, sideband VLIW processor 200 can execute superscalar instructions without sideband information. Sideband VLIW processor 200 can simply execute one instruction at a time in the order presented in the instruction stream. Although this won't give a speed advantage over superscalar processors, this technique allows sideband VLIW processor 200 to execute superscalar code both with and without sideband information.

In another embodiment, sideband information is used to control the required latency (delay) for execution of instructions on a single functional unit.

Sideband Information

According to an embodiment of the present invention, sideband information corresponding to an executable file is provided. The sideband information can be used by a sideband VLIW processor to schedule and group superscalar instructions for execution. Sideband information is not part of the executable program, but “off-to-the-side,” either in the same file or a different file. No changes are made to the instruction portion of the executable file. The sideband information is ignored by superscalar processors executing the executable file. Thus object code compatibility is provided between sideband VLIW processors and superscalar processors.

Multiple sets of sideband information can be provided for a given executable file, one set for each of several different sideband VLIW processor architectures. For example, one set of sideband information can be provided for a sideband VLIW processor with four parallel execution units groups to coordinate the execution of up to four instructions at a time and another set of sideband information can be provided for a sideband VLIW processor with eight parallel execution units groups to coordinate the execution of up to eight instructions at a time.

Sideband information is encoded so that a sideband VLIW processor can determine which instruction corresponds to which portion of the sideband information. The sideband information can be encoded in many different ways.

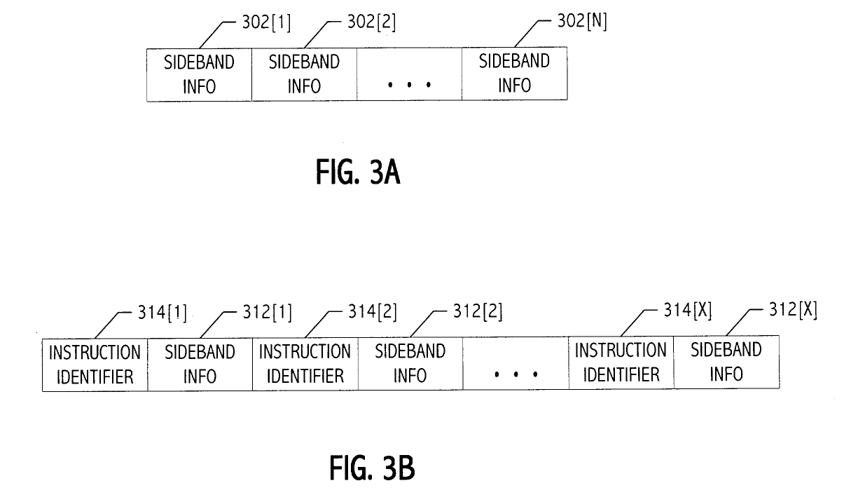

FIGS. 3A-3B illustrate exemplary encoding formats for sideband information according to embodiments of the present invention.

FIG. 3A illustrates a fixed size sideband information encoding according to an embodiment of the present invention. As shown, multiple groups of sideband information 302[1:N] have a fixed size and correspond to N instructions in associated executable code. Sideband information 302[1] corresponds to a first instruction, sideband information 302[2] corresponds to a second instruction, and so on. Using a base address of the sideband information and a fixed size of the portion of the sideband information relating to a particular address, for example two bytes, the sideband information relating to the sixth instruction would be found at the base address plus 12 byte locations.

FIG. 3B illustrates an encoding with explicit instruction identification encoding according to an embodiment of the present invention. Each group of sideband information 312[1:X] is preceded by one or more bytes 314[1:X] indicating a corresponding instruction in the executable file. Sideband information is related to the original instructions, for example, by specifying addresses (program counter values) in the executable program to which the sideband information corresponds. The correspondence between the sideband information and the executable code can be, for example, at the individual instruction level or at the page level.

Sideband information can identify such information as which instructions are to be executed each cycle (also referred to as grouping). This might be encoded with sideband information that indicates at a particular instruction that the following N instructions are able to be executed in parallel. The sideband information may also identify that one instruction has no dependencies on the next N instructions forward or backward.

Sideband information can also identify which functional unit is to execute each instruction. Sideband information can also identify whether any interlocks preventing instructions from executing immediately exist. For example, an instruction can have to wait three cycles because of a previous instruction.

Sideband information can also identify microcode level control of the sideband VLIW processor. For example, the sideband information can identify which communication paths are used to send the contents of a register to a functional unit or which bits are set on a multiplexer to get the correct register out of a register file.

Sideband information can also identify bypass or forwarding information between stages of a processor pipeline. When executing instructions, different operations happen at each pipeline stage. In the first stage, a register file can be read and the value obtained can be sent to a functional unit, for example, an arithmetic logic unit. In the second stage, the functional unit can calculate a result from values obtained. In the third stage, the result can be written to a register file. When a result of a first instruction is an input variable to a second instruction, rather than writing the result to the register file and then reading it again, the result can be bypassed or forwarded to the input of the functional unit, saving two stages of processing time. Sideband information can specify which instruction result is to be bypassed and to which functional unit the result is to be sent.

Sideband Compiler Architecture

Sideband information can be provided by a sideband compiler during the translation of source code into an executable file. Alternatively, a software tool can read the executable program and produce one or more sets of sideband information for a particular sideband VLIW processor architecture. In another embodiment, a programmer produces sideband information at the assembly language level while programming source code. An interpreter or just-in-time (JIT) compiler can also produce the sideband information.

Source code written by a programmer is a list of statements in a programming language such as C, Pascal, Fortran and the like. Programmers perform all work in the source code, changing the statements to fix bugs, adding features, or altering the appearance of the source code. A compiler is typically a software program that converts the source code into an executable file that a computer or other machine can understand. The executable file is in a binary format and is often referred to a binary code. Binary code is a list of instruction codes that a processor of a computer system is designed to recognize and execute. Binary code can be executed over and over again without recompilation. The conversion or compilation from source code into binary code is typically a one-way process. Conversion from binary code back into the original source code is typically impossible.

A different compiler is required for each type of source code language and target machine or processor. For example, a Fortran compiler typically can not compile a program written in C source code. Also, processors from different manufacturers typically require different binary code and therefore a different compiler or compiler options because each processor is designed to understand a specific instruction set or binary code. For example, an Apple Macintosh's processor understands a different binary code than an IBM PC's processor. Thus, a different compiler or compiler options would be used to compile a source program for each of these types of computers.

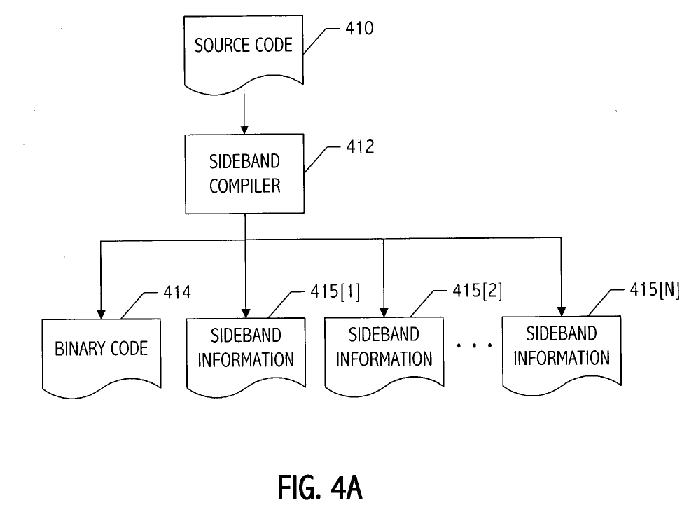

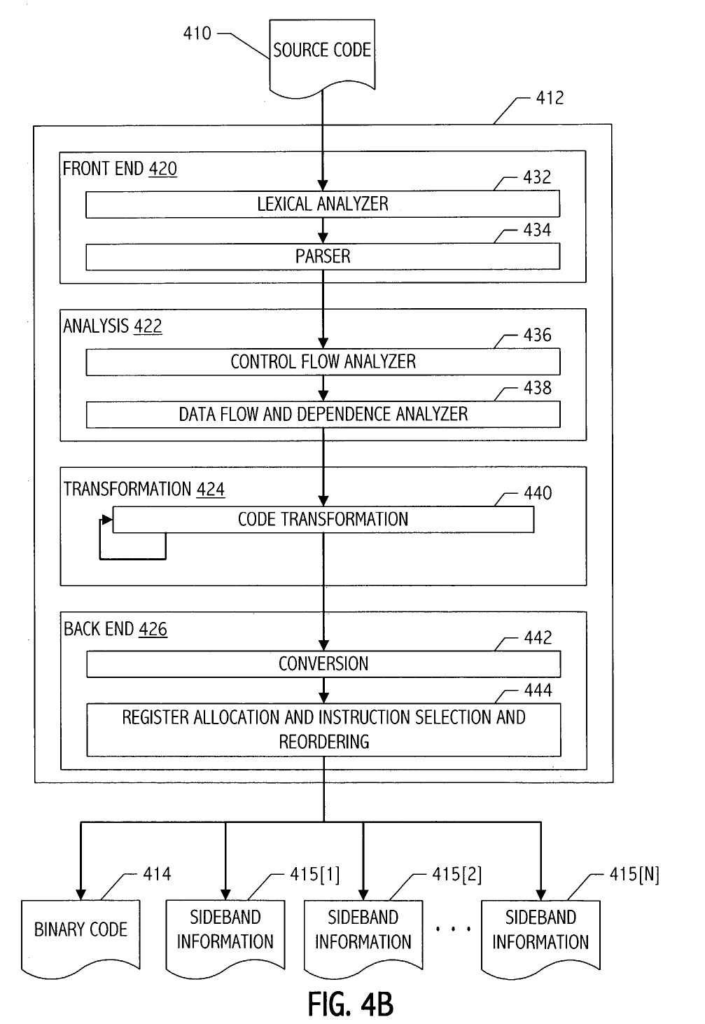

FIG. 4A illustrates an exemplary compilation process according to an embodiment of the present invention. Source code 410 is read into sideband compiler 412. Source code 410 is a list of statements in a programming language such as C, Pascal, Fortran and the like. Sideband compiler 412 collects and reorganizes (compiles) all of the statements in source code 410 to produce a binary code 414 and one or more sideband information files 415[1:N]. Binary code 414 is an executable file in a binary format and is a list of instruction codes that a processor of a computer system is designed to recognize and execute. Sideband information can be included in the same file as the executable code, or alternatively, in one or more separate files. An exemplary compiler architecture according to an embodiment of the present invention is shown in FIG. 4B.

In the compilation process, sideband compiler 412 examines the entire set of statements in source code 410 and collects and reorganizes the statements. Each statement in source code 410 can translate to many machine language instructions or binary code instructions in binary code 414. There is seldom a one-to-one translation between source code 410 and binary code 414. During the compilation process, sideband compiler 412 may find references in source code 410 to programs, sub-routines and special functions that have already been written and compiled. Sideband compiler 412 typically obtains the reference code from a library of stored sub-programs which is kept in storage and inserts the reference code into binary code 414. Binary code 414 is often the same as or similar to the machine code understood by a computer. If binary code 414 is the same as the machine code, the computer can run binary code 414 immediately after sideband compiler 412 produces the translation. If binary code 414 is not in machine language, other programs (not shown)-such as assemblers, binders, linkers, and loaders-finish the conversion to machine language. Sideband compiler 412 differs from an interpreter, which analyzes and executes each line of source code 410 in succession, without looking at the entire program.

FIG. 4B illustrates an exemplary compiler architecture for sideband compiler 412 according to an embodiment of the present invention. Compiler architectures can vary widely; the exemplary architecture shown in FIG. 4B includes common functions that are present in most compilers. Other compilers can contain fewer or more functions and can have different organizations. Sideband compiler 412 contains a front-end function 420, an analysis function 422, a transformation function 424, and a back-end function 426.

Front-end function 420 is responsible for converting source code 410 into more convenient internal data structures and for checking whether the static syntactic and semantic constraints of the source code language have been properly satisfied. Front-end function 420 typically includes two phases, a lexical analyzer 432 and a parser 434. Lexical analyzer 432 separates characters of the source language into groups that logically belong together; these groups are referred to as tokens. The usual tokens are keywords, such as DO or IF, identifiers, such as X or NUM, operator symbols, such as <=or +, and punctuation symbols such as parentheses or commas. The output of lexical analyzer 432 is a stream of tokens, which is passed to the next phase, parser 434. The tokens in this stream can be represented by codes, for example, DO can be represented by 1, +by 2, and “identifier” by 3. In the case of a token like “identifier,” a second quantity, telling which of those identifiers used by the code is represented by this instance of token “identifier,” is passed along with the code for “identifier.” Parser 434 groups tokens together into syntactic structures. For example, the three tokens representing A+B might be grouped into a syntactic structure called an expression. Expressions might further be combined to form statements. Often the syntactic structure can be regarded as a tree whose leaves are the token. The interior nodes of the tree represent strings of tokens that logically belong together.

Analysis function 422 can take many forms. A control flow analyzer 436 produces a control-flow graph (CFG). The control-flow graph converts the different kinds of control transfer constructs in a source code 410 into a single form that is easier for sideband compiler 412 to manipulate. A data flow and dependence analyzer 438 examines how data is being used in source code 410. Analysis function 422 typically uses program dependence graphs and static single-assignment form, and dependence vectors. Some compilers only use one or two of the intermediate forms, while others use multiple intermediate forms.

After analyzing source code 410, sideband compiler 412 can begin to transform source code 410 into a high-level representation. Although FIG. 4B implies that analysis function 422 is complete before transformation function 424 is applied, in practice it is often necessary to re-analyze the resulting code after source code 410 has been modified. The primary difference between the high-level representation code and binary code 414 is that the high-level representation code need not specify the registers to be used for each operation.

Code optimization (not shown) is an optional phase designed to improve the high-level representation code so that binary code 414 runs faster and/or takes less space. The output of code optimization is another intermediate code program that does the same job as the original, but perhaps in a way that saves time and/or space.

Once source code 410 has been fully transformed into a high-level representation, the last stage of compilation is to convert the resulting code into binary code 414. Back-end function 426 contains a conversion function 442 and a register allocation and instruction selection and reordering function 444. Conversion function 442 converts the high-level representation used during transformation into a low-level register-transfer language (RTL). RTL can be used for register allocation, instruction selection, and instruction reordering to exploit processor scheduling policies.

A table-management portion (not shown) of sideband compiler 412 keeps track of the names use by the code and records essential information about each, such as its type (integer, real, floating point, etc.) and location or memory address. The data structure used to recode this information is called a symbol table.

Sideband compiler 412 produces sideband information for a sideband VLIW processor defining, for example, the grouping (which instructions) or how many instructions are to be executed in a single cycle. Sideband compiler 412 performs instruction reordering or scheduling to maximize the number of instructions executed every cycle. The sideband compiler takes into account, for example, load latency, and reorders instructions accordingly. Sideband compiler 412 understands processor architecture and bypassing/forwarding functions. Sideband compiler 412 understands instruction dependencies and how many cycles with which to separate instructions. For example, sideband compiler 412 determines if two instructions are dependent, places them, for example, three cycles apart, and programs the bypass functionality.

Realizations in accordance with the present invention have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the exemplary configurations may be implemented as a combined structure or component. These and other variations, modifications, additions, and improvements may fall within the scope of the invention as defined in the claims that follow.

What is claimed is:

1. A processor comprising:
a functional unit for executing a sequence of processor instructions; and
sideband interpreter configured to process sideband information corresponding to the sequence of processor instructions.

2. The processor as recited in claim 1, wherein the sideband interpreter is further configured to order, group, and dispatch the sequence of instructions to the functional unit according to the sideband information.

3. The processor as recited in claim 1, wherein the sideband interpreter is further configured to coordinate execution of multiple instructions of the sequence of processor instructions in a same clock cycle.

4. The processor as recited in claim 1, wherein the sideband interpreter is further configured to delay execution of successive instructions of the sequence of processor instructions.

5. The processor as recited in claim 1, wherein the sideband interpreter is further configured to reorder for execution successive instructions of the sequence of processor instructions.

6. The processor as recited in claim 1, wherein the sideband interpreter is further configured to group for execution successive instructions of the sequence of processor instructions.

7. The processor as recited in claim 1, wherein the sideband information is stored in an instruction cache.

8. The processor as recited in claim 1, wherein a portion of the sideband information corresponding to a particular instruction of the sequence of processor instructions is located utilizing a program counter for the sequence of processor instructions.

9. The processor as recited in claim 1, further comprising:
sideband program counter, and
sideband translation look-aside buffer (TLB);
wherein the sideband program counter and the sideband translation look-aside buffer work in conjunction to track and translate an instruction address to the corresponding sideband information address.

10. The processor as recited in claim 9, wherein the sideband TLB contains a searchable set of entries, the set of entries searchable by one or more of an instruction page address and a sideband information page address.

11. The processor as recited in claim 9, wherein the sideband TLB contains a searchable set of entries, the set of entries searchable by one or more of an instruction segment base address, an instruction segment size, a sideband information segment base address, and a scaling factor.

12. The processor as recited in claim 1, wherein the sideband interpreter is further configured to:
coordinate bypassing the functional unit and another functional unit.

13. The processor as recited in claim 1, wherein the sideband interpreter is further configured to:
identify which communication paths between a register and the functional unit are to be used to send a variable from the register to the functional unit.

14. The processor as recited in claim 1, wherein the sideband interpreter is further configured to:
identify which communication paths between the functional unit and a register are to be used to send a variable from the functional unit to the register.

15. The processor as recited in claim 1, wherein the sideband interpreter is further configured to:
identify which communication paths between the functional unit and another functional unit are to be used to send a variable from the functional unit to the another functional unit.

16. The processor as recited in claim 1, wherein the sideband information is a sequence of sideband instructions stored on computer readable media with the sequence of processor instructions.

17. The processor as recited in claim 1, wherein a different set of sideband information is used for a different processor implementation.

18. A processor integrated circuit operable to:
in response to a first sequence of sideband information, dispatch a plurality of instructions to a plurality of functional units for execution.

19. The processor integrated circuit as recited in claim 18, wherein the sequence of sideband information is stored on computer readable media with the plurality of instructions.

20. The processor integrated circuit as recited in claim 18, wherein the processor integrated circuit is further operable to:
in response to a second sequence of sideband information, coordinate bypassing between the plurality of functional units.

21. The processor integrated circuit as recited in claim 18, wherein the processor integrated circuit is further operable to:
in response to a second sequence of sideband information, identify which communication paths between one of the plurality of functional units and a register are to be used to send a variable between the register and the one of the plurality of more functional units.

22. A method of operating a processor comprising:
parsing a sequence of processor instructions and associated sideband information; and
ordering, grouping and dispatching to a plurality of functional units the sequence of processor instructions as directed by the associated sideband information.

23. The method as recited in claim 22, further comprising:
coordinating bypassing between the plurality of functional units as directed by the associated sideband information.

24. The method as recited in claim 22, further comprising:
identifying which communication paths between the plurality of functional units and a register are to be used to send a variable between the register and one of the plurality of functional units as directed by the associated sideband information.

25. The method as recited in claim 22, wherein the associated sideband information is a sequence of instructions stored on computer readable media with the sequence of processor instructions.

26. A method comprising:
generating a sequence of sideband information that corresponds to a sequence of processor instructions executable by a processor;
wherein the sequence of sideband information instructs the processor on an order and a grouping for execution of the sequence of processor instructions.

27. The method as recited in claim 26, further comprising:
generating the sequence of processor instructions from source code.

28. The method as recited in claim 26, further comprising:
first parsing the sequence of processor instructions.

29. The method as recited in claim 26, wherein the sequence of sideband information further coordinates bypassing between two or more functional units.

30. The method as recited in claim 26, further comprising:
generating another sequence of sideband information that corresponds to the sequence of processor instructions; wherein the first sequence and the second sequence are for different processor architectures.

31. Software encoding in one or more computer readable media, the software comprising:
sideband information corresponding to a sequence of instructions executable on a processor;
wherein the sideband information is configured to instruct the processor on an order and a grouping for execution of the sequence of processor instructions.

32. An apparatus comprising:
means for parsing a sequence of processor instructions and associated sideband information; and
means for ordering, grouping and dispatching to a plurality of functional units the sequence of processor instructions as directed by the associated sideband information.

33. The apparatus as recited in claim 32, further comprising:
means for coordinating bypassing between the plurality of functional units as directed by the associated sideband information.

34. The apparatus as recited in claim 32, further comprising:
means for identifying which communication paths between the plurality of functional units and a register are to be used to send a variable between the register and one of the plurality of functional units as directed by the associated sideband information.

35. The apparatus as recited in claim 32, wherein the associated sideband information is a sequence of instructions stored on computer readable media with the sequence of processor instructions.

36. An apparatus comprising:
means for generating a sequence of sideband information that corresponds to a sequence of processor instructions executable by a processor;
wherein the sequence of sideband information instructs the processor on an order and a grouping for execution of the sequence of processor instructions.

37. The apparatus as recited in claim 36, further comprising:
means for generating the sequence of processor instructions from source code.

38. The apparatus as recited in claim 36, further comprising:
means for first parsing the sequence of processor instructions.

39. The apparatus as recited in claim 36, wherein the sequence of sideband information further coordinates bypassing between two or more functional units.

40. The apparatus as recited in claim 36, further comprising:
means for generating another sequence of sideband information that corresponds to the sequence of processor instructions; wherein the first sequence and the second sequence are for different processor architectures.

41. A computer readable media product comprising:
a sequence of executable instructions for execution by a processor; and
a set of sideband information corresponding to the sequence of executable instructions; wherein the set of sideband information identifies an order and grouping of the sequence of executable instructions for execution by the processor.

42. The computer readable media product as recited in claim 41, wherein the set of sideband information further identifies a location in the sequence of executable instructions to delay execution of successive instructions of the sequence of processor instructions.

43. The computer readable media product as recited in claim 41, wherein the set of sideband information further identifies a reorder for execution of successive instructions of the sequence of processor instructions.

44. The computer readable media product as recited in claim 41, wherein the set of sideband information further identifies a group for execution of successive instructions of the sequence of processor instructions.

45. The computer readable media product as recited in claim 41, wherein the set of sideband information further identifies a coordination of bypassing between one functional unit and another functional unit of the processor.

46. The computer readable media product as recited in claim 41, wherein the set of sideband information further identifies which communication paths between a register and a functional unit of the processor are to be used to send a variable from the register to the functional unit.

47. The computer readable media product as recited in claim 41, wherein the set of sideband information further identifies which communication paths between a functional unit and a register of the processor are to be used to send a variable from the functional unit to the register.

48. The computer readable media product as recited in claim 41, wherein the set of sideband information further identifies which communication paths between a functional unit and another functional unit of the processor are to be used to send a variable from the functional unit to the another functional unit.

49. The computer readable media product as recited in claim 41, further comprising:
another set of sideband information corresponding to the sequence of executable instructions; wherein the another set of sideband information identifies another order and grouping of the sequence of executable instructions for execution by another processor
